(19) United States
(12) Patent Application Publication
(10) Pub. No.: US 2018/0005234 A1
(43) Pub. Date: Jan. 4, 2018

(54) Generating and Dynamically Modifying User Interface Elements

(71) Applicant: Bank of America Corporation, Charlotte, NC (US)

(72) Inventors: Melissa Kay Van Leuven, Avondale, AZ (US); Benedict John Gessler, III, Lake Wylie, SC (US); Kimberly D. Dewberry, Charlotte, NC (US)

(21) Appl. No.: 15/196,369

(22) Filed: Jun. 29, 2016

(51) Int. Cl. G06Q 20/40

(52) U.S. Cl. CPC G06Q 20/407; G06Q 20/401

(57) ABSTRACT

Systems and arrangements for evaluating and decisioning refund requests and monitoring of overrides of refund decisions are presented. In response to receiving a request for a refund, the system may identify one or more sources of data from which to extract data to determine a decision regarding the request for refund. In some examples, a type or amount of data transmitted to be used in determining the decision may be controlled by the device. Further, user input associated with requests to override the refund decision may be continuously monitored. A determination may be made as to whether a number of occurrences of overrides for a particular user, customer, or account, has met a first threshold. If so, one or more parameters of the system may be dynamically modified and a user interface reflecting the modified parameters may be dynamically modified. Additional determinations may also be made and dynamic modifications may be performed.

### BACKGROUND

Aspects of the disclosure relate to computer hardware and software. In particular, one or more aspects of the disclosure generally relate to computer hardware and software for generating and dynamically modifying user interface elements.

Entities often deal with requests from customers that may be of a subjective nature. For instance, determining whether to provide a refund to a user for a cost charged to them and for which they are requesting a refund for one of various reasons can be a subjective decision to make. Further, having different users making decisions of this nature can lead to different factors being considered (or not considered) and the like. Accordingly, systems for automatically determining an objective decision may be advantageous. In addition, continuous monitoring of users requesting overrides of the automatically determined objective decision and adjusting one or more parameters of the system based on the monitoring may also be advantageous.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to computer systems and arrangements that provide for evaluation of a refund request, decisioning of a refund request, and monitoring of overrides of refund decisions. In some examples, the arrangements may include receiving user input requesting a refund of a cost. The system may identify one or more sources of data from which to extract data to determine a decision regarding the request for refund. In some examples, a type or amount of data transmitted to be used in determining the decision may be controlled by the device.

In some arrangements, user input associated with requests to override the refund decision may be continuously monitored (e.g., in real-time). A determination may be made as to whether a number of occurrences of overrides for a particular user, customer, account, group of accounts, or the like, has met a first threshold. Responsive to determining that the first threshold is met, one or more parameters of the system may be dynamically modified and a user interface reflecting the modified parameters may be dynamically modified.

In some examples, the system may determine whether a second threshold including a number of times the first threshold has been met, has been met. Responsive to determining that the second threshold has been met, the first threshold may be dynamically modified and a user interface reflecting the modification may be dynamically generated.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an illustrative refund evaluation and decisioning computing platform for evaluating refund requests and monitoring overrides according to one or more aspects described herein;

FIGS. 2A-2D depict an illustrative event sequence for evaluating and decisioning refund requests and monitoring overrides to dynamically modify users interfaces according to one or more aspects described herein;

FIGS. 3A-3B depict an illustrative event sequence for controlling data used in evaluating and decisioning refund requests and monitoring overrides according to one or more aspects described herein;

FIG. 4 illustrates one example method of monitoring override requests and dynamically modifying aspects of the systems described herein according to one or more aspects described herein;

FIG. 5 illustrates one example user interface providing a notification of a refund decision according to one or more aspects described herein;

FIG. 6 illustrates one example user interface providing a notification that a threshold has been dynamically modified according to one or more aspects described herein;

FIG. 7 illustrates one example operating environment in which various aspects of the disclosure may be implemented in accordance with one or more aspects described herein; and

FIG. 8 depicts an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As discussed herein, entities often receive requests for refunds of costs charged to a customer. For instance, a cost charged to a user on a particular product of the entity may seem unfair to the customer, the customer might not be able to afford to pay the cost, or the like. Accordingly, upon receiving a request for a refund, the systems and arrangements provided herein may evaluate information related to the user inputting the request, the customer requesting the refund, the product, a relationship between the customer and the entity, and the like, to determine whether the refund request may be granted.

In some examples, a user inputting the refund may desire to override the refund decision made. For instance, if the user feels that the refund should be paid but the refund decision was that the refund should not be paid, the user may, in at least some arrangements, override the refund decision. However, some users, roles, accounts, customers, particular refunds, or the like may require secondary approval before the override may be granted. Accordingly, monitoring of requested overrides for various users, products, refunds, accounts, customers, and the like, may aid in understanding a number of overrides being implemented (either with or without secondary authorization), which user(s) are requesting the overrides, particular customers for whom overrides occur, and the like. Accordingly, the system described herein may dynamically modify parameters, requirements for secondary approval, and the like, based on the monitoring.

In addition, aspects described herein relate to use of question prompts to the user to ensure that the user understand why a refund request is being made, why an override is being requested, why secondary approval is required, and the like. Not only does this provide an efficient and thorough way to ensure accuracy in the system, it also provides a log of decisions made by various users, for various customers or accounts, and the like.

These and various other arrangements will be discussed more fully herein.

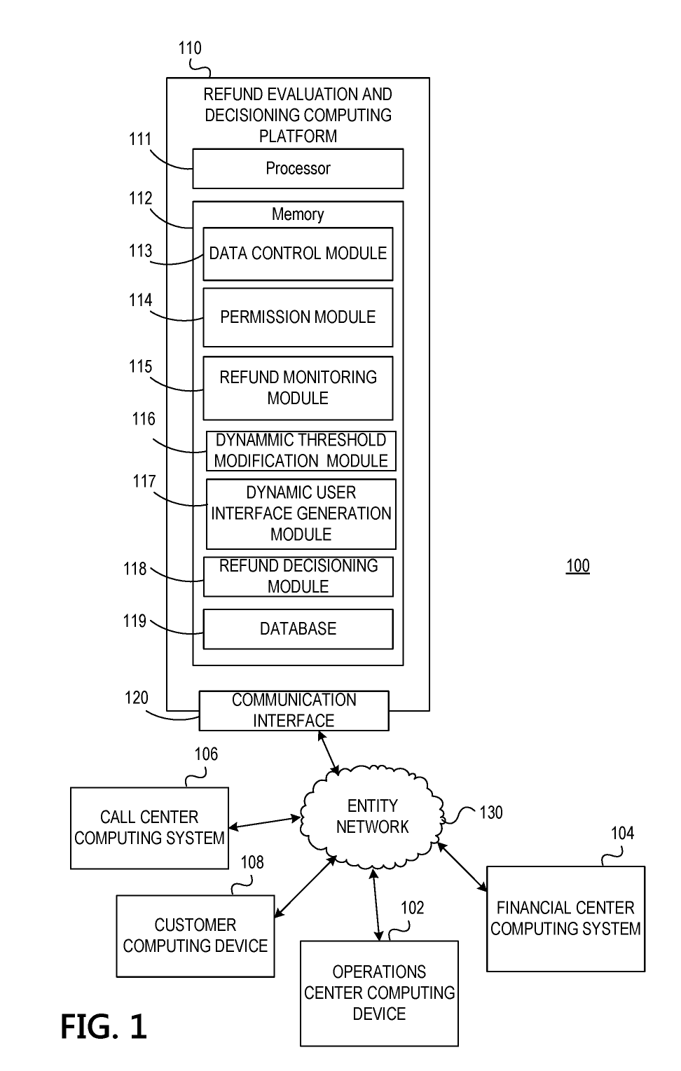

FIG. 1 depicts an environment 100 including an illustrative computing platform for refund evaluation and decisioning according to one or more aspects described herein. For instance, the environment 100 includes a refund evaluation and decisioning computing platform 110, which may include one or more processors 111, memory 112, and communication interface 120. A data bus may interconnect processor(s) 111, memory 112, and communication interface 120. Communication interface 120 may be a network interface configured to support communication between refund evaluation and decisioning computing platform 110 and one or more networks (e.g., network 130). One or more computing or other devices 102, 104, 106, 108 may be in communication with the refund evaluation and decisioning computing platform 110 (e.g., via network 130). Memory 112 may include one or more program modules having instructions that when executed by processor(s) 111 cause the refund evaluation and decisioning computing platform 110 to perform one or more functions described herein, and/or one or more databases that may store and/or otherwise maintain information which may be used by such program modules and/or processor(s) 111. In some instances, the one or more program modules and/or databases may be stored by and/or maintained in different memory units of refund evaluation and decisioning computing platform 110 and/or by different computer systems or devices that may form and/or otherwise make up the refund evaluation and decisioning computing platform 110. In some arrangements, different features or processes performed may be performed by different sets of instructions, such that the processor may execute each desired set of instructions to perform different functions described herein.

For example, memory 112 may include a refund decisioning module 118. The refund decisioning module 118 may include hardware and/or software configured to perform various functions within the refund evaluation and decisioning computing platform 110. For instance, a user, such as an associate in a financial institution, may provide user input requesting a refund for a customer. For example, various costs may be associated with different accounts or products of a financial institution. In some examples, these costs are charged to customers upon not meeting one or more requirements of the account or product. In other examples, the costs may be charged as part of the parameters of the account or product. However, a customer or user may request a refund of a cost charged to a customer. This request may be made via various channels (e.g., in person, via an online or other banking application, via a call center request, or the like).

The request for a refund of one or more costs may be submitted via, for example, operations center computing device 102. Operations center computing device 102 may be a user computing device used or engaged by a user inputting a request for a refund, such as a banking associate. The operations center computing device 102 may be in communication with the refund evaluation and decisioning computing platform 110 via network 130 and may be one of various types of computing devices. For instance, the operations center computing device 102 may be a tablet computing device, laptop computing device, desktop computing device, mobile device, or the like, specially configured to perform functions associated with an entity employing the refund evaluation and decisioning tool. For example, operations center computing device 102 may be an associate computing device in a banking location, a call center associate computing device, a device of a user executing an online other application (similar to device 108), or the like.

In some examples, the request for the refund may include a refund reason code. The refund reason code may include one or more reasons for which a refund is being requested. For example, the refund may be requested due to a hardship on the part of the customer (e.g., a death in the family). In another example, the refund may be requested due to a potential error on the part of the entity. Various other reason codes may be provided in the request.

Additionally or alternatively, the refund request may include an amount of the cost to be refunded. This information (e.g., refund code, cost, and the like) may be used by the refund decisioning module 118 to determine whether a refund will be granted. The decision may be based on one or more rules stored in the refund decisioning module that may be applied. The rules may be applied by evaluation the received information as well as other information stored in one or more databases 120 associated with the refund evaluation and decisioning computing platform 110. In some examples, refunds of different costs may have different rules (e.g., the system may be more likely to grant a greater number of refunds on lower value refunds and fewer higher value refunds, or the like).

In some arrangements, refund decisions made by the refund decisioning module (and/or the refund evaluation and decisioning computing platform 110) may be stored for future use, such as in database 120. The stored refund decisions may include information related to an amount of the refund or amount of the cost refunded, an account associated with the refund, a customer associated with the refund and/or a user requesting the refund. In some examples, the stored refund decisions may include data, types of data or sources of data used in the decisioning process. Accordingly, as subsequent requests for a refund are received by the refund decisioning module 118, the system may extract historical data related to previously granted refunds to that customer or account, as well as historical request data associated with the user. This information may be used in determining whether a future refund may be granted or in understanding why a previous refund request was not granted. In addition, the data used in making a refund decision, as will be discussed more fully below, may also be stored (or identification of the data used may be stored) such that subsequent requests for the same refund may be decisioned based on the same data to result in a same outcome, thereby providing consistency.

In some examples, as mentioned above, the refund decision may be based on additional information extracted from one or more databases. For example, the refund decisioning module 118 may request information from one or more computing systems (such as call center computing system 106, financial center computing system 104, one or more databases associated with loans, accounts, mortgages, and the like). The various computing systems and databases may be in communication with the refund evaluation and decisioning computing platform 110 via the network 130. Accordingly, the refund decisioning module 118 may transmit a request for additional information to one or more computing systems. The information requested may include information associated with the customer for whom the refund request is being made. For example, an amount of funds or business the customer conducts with the entity, a period of time for which the customer has been a customer of the entity, type of accounts, loans, or the like, the customer has with the entity, and the like.

In some arrangements, this information may be stored in various different computing systems, as indicated above. Accordingly, upon transmitting the request for additional information, a data control module 113 may be activated. The data control module 113 may include hardware and/or software configured to perform various functions within the refund evaluation and decisioning computing platform 110. For instance, the data control module 113 may be automatically activated or initiated upon the request for additional information being transmitted. The data control module 113 may then evaluate the refund request, refund reason code, amount of refund, and the like, and may identify one or more appropriate sources of data to access. That is, the data control module 113 may control the source of the data provided to the refund decisioning module 118. The data control module 113 may determine, based on the refund reason code, type or amount of requested refund, or the like, the system or database from which to extract information for the refund decisioning module 118. In one example, a refund for a cost associated with a checking account may be extracted from the financial center computing system 104 and/or associated database. In another example, information related to a number of previous refund requests may be extracted from a call center computing system 106. Various other examples of data being extracted from different systems may be used without departing from the invention.

Upon determining the appropriate source of the information, the data control module 113 may further control an amount of data transmitted to the refund decisioning module 118. For instance, the data control module 113 may regulate or control an amount of data used in the refund decision. The data control module 113 may determine, based on a refund request code, amount of refund or cost to be refunded, or the like, an amount of data to provide to the refund decisioning module 118. The amount of data may include data collected over a predetermined period of time, data associated with a predetermined number of previous requests, or the like.

The additional information may then be extracted from the identified sources, as controlled by the data control module 113, and may be used to determine whether a refund request will be granted.

Upon the refund decision being made, the decision may be transmitted to a user, e.g., via operations center computing device 102, and/or to a customer via computing device 108. In at least some examples in which a user is making a refund request for a customer, the user may override (or request to override) the decision of the refund decisioning module. For instance, if the refund decisioning module 118 determines that a refund of a cost should not be made, the user may override the decision of the refund decisioning module 118 and may provide the refund to the customer.

In some examples, the ability of a user to override a decision of the refund decisioning module 118 may be based on one or more predetermined permissions associated with the user. For instance, refund evaluation and decisioning computing platform 110 may include a permission module 114. The permission module 114 may include hardware and/or software configured to perform various functions within the refund evaluation and decisioning computing platform 110. For instance, the permission module 114 may receive an override request from a user. The request may include a name of a user requesting the override, an employee number or other unique identifier associated with the user, a role of the user (e.g., teller, banking associate, supervisor, administrator, or the like), and the like. The permission module 114 may compare the received information with prestored permissions for one or more users. For instance, the permission module 114 may include a lookup table that may store predetermined permissions for various users, roles and the like. Accordingly, the permission module may query a lookup table to determine whether the user making the request is authorized to override the refund decision. In some examples, the determination of whether the user is authorized to override the decision may be based on a role defined for the user (e.g., all users of a first role may be able to override decisions but users of a second role might not).

In some arrangements, different users or roles may have different permissions based on a type of refund, amount of refund, or the like. For instance, users in a first role may be authorized to override refund decisions of less than a certain dollar amount but may not be authorized to override refund decisions over the certain dollar amount without secondary approval. In some examples, different refunds may be grouped (e.g., by amount, by type of cost, by type of refund, or the like). Permissions may then be provided for each group of refunds, rather than for individual refunds, in these arrangements. Various other examples of permissions varying based on an amount of refund may be provided without departing from the invention.

In some arrangements in which a user is not authorized to override the decision of the refund decisioning module 118, a secondary approval may be required in order to override the decision. For instance, the permission module 114 may determine that a first user is not authorized to override the decision. Accordingly, the permission module 114 may generate a notification indicating that secondary approval may be required. The permission module 114 may cause the notification to be displayed on the operations center computing device 102.

The refund evaluation and decisioning computing platform 110 may further include a refund monitoring module 115. The refund monitoring module 115 may include hardware and/or software configured to perform various functions within the refund evaluation and decisioning computing platform 110. For instance, the refund monitoring module 115 may continuously monitor, in real-time, refund requests received by the refund evaluation and decisioning computing platform 110, users requesting refunds, customers for whom refunds are requested, accounts for which refunds are requested, requests for overrides, customer associated with requested overrides, account associated with requested override, and the like. In some examples, the refund monitoring module 115 may compare the data received (e.g., a number of requests for a refund for a particular customer, a number of requests by a particular user, a number of requests for a particular account, and the like) within a predetermined amount of time (e.g., one week, one month, six months, one year, or the like) to a first predetermined threshold number of occurrences.

In some arrangements, the threshold may vary based on the criteria being considered. For instance, if the system is comparing a number of overrides for a particular user, the threshold used may be different from the threshold used when comparing a number of overrides for a particular customer or a particular account. In some examples, each threshold may be different from the others. In other examples, two or more threshold may be the same, or all thresholds considered may be the same.

Upon reaching the first predetermined threshold, the system may modify one or more requirements, processes, or the like. For instance, if the first threshold is reached, secondary approval of a refund or override request for the particular user, account, or the like, may be required. Accordingly, one or more user interfaces may be modified or generated via a dynamic user interface generation module 117.

The dynamic user interface generation module 117 may include hardware and/or software configured to perform various functions within the refund evaluation and decisioning computing platform 110. For instance, upon determining, by the refund monitoring module 115 that a first predetermined threshold has been met, the system may modify one or more requirements. For instance, secondary approval may be required for the particular user who reached the first threshold, the customer associated with the request that met the first threshold, the account associated with the request that met the first threshold, and the like. Accordingly, the refund monitoring module 115 may instruct or cause the dynamic user interface generation module 117 to dynamically generate, in real-time, one or more user interfaces indicating the modified parameters or requirements (e.g., that secondary approval is required).

In some examples, the dynamic user interface generation module 117 may generate various user interfaces that may be presented to a user throughout the refund and/or override process. For instance, upon requesting a refund, the dynamic user interface generation module 117 may generate one or more user interfaces including questions to be answered by the user. This may aid in maintaining consistency throughout the system while efficiently logging the actions of the user, as well as the reasoning used by the user.

In some examples, different user interfaces may be generated for each user action taken (e.g., request for refund, refund reason code selected, request for override, and the like). The user interface generated may be a single user interface or may be a series of user interfaces. In the case of a series of user interfaces, subsequent user interfaces might not be generated until a user provides user input in response to a previous user interface and associated question. This may also aid in limiting or controlling the reasoning used by users, the responses provided by users, and the like. For instance, in comparison to the use of drop-down menus which provide all options available to a user, the series of user interfaces may limit the user to only the questions asked and/or the options provided for response.

In some examples, the refund monitoring module 115 may determine, in real-time, that the first threshold should be modified. For instance, if a particular user, customer, or account has met the first threshold a predetermined number of times (e.g., a second threshold number of times) in a predefined period of time, or the like, the refund monitoring module 115 may determine that the first threshold should be lowered. Accordingly, an instruction may be transmitted to a dynamic threshold modification module 116 to modify the first predetermined threshold.

The dynamic threshold modification module 116 may include hardware and/or software configured to perform various functions within the refund evaluation and decisioning computing platform 110. For instance, the dynamic threshold modification module 116 may receive the instruction to modify the first threshold and may dynamically modify the predetermined first threshold (e.g., higher or lower than the previous threshold) and may implement the modified first threshold in real time. The dynamic threshold modification module 116 may generate a notification to an appropriate party (e.g., a user, the entity, a supervisor, or the like) of the modified first threshold and may cause the notification to be displayed on one or more computing devices 102.

Further, the modification of the first threshold may cause the dynamic user interface generation module 117 of the refund evaluation and decisioning computing platform 110 to dynamically generate one or more modified user interfaces that may be displayed to a user. For instance, prior to modifying a threshold, a first user interface through which a user may request to override a refund decision may include a field for inputting the user's name, unique identifier or the like. The user interface may indicate that no additional approval or may include other information directed to overrides, refund decisions, and the like.

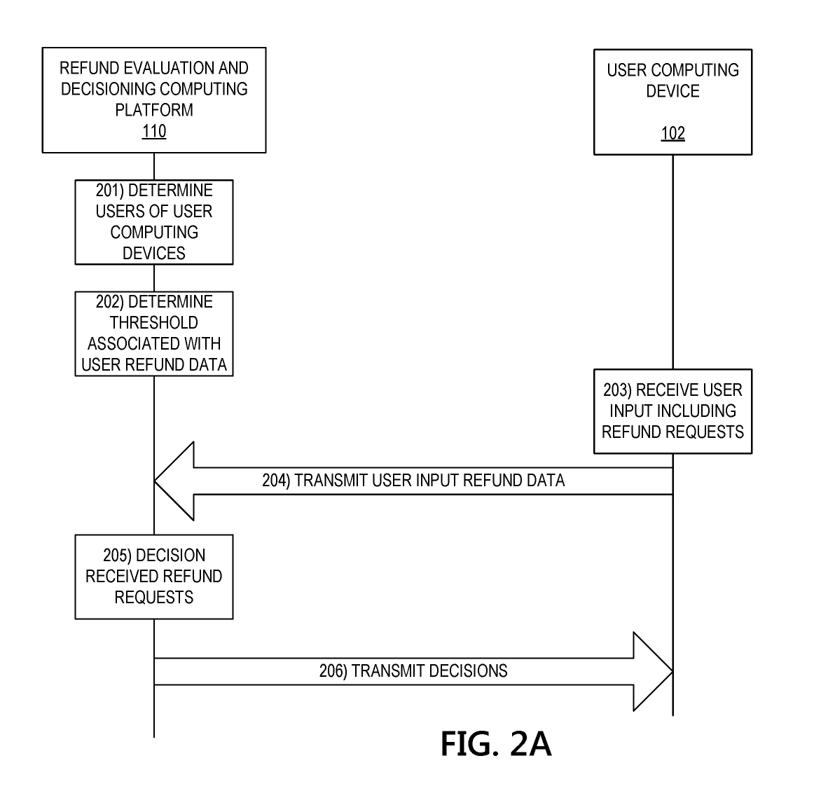

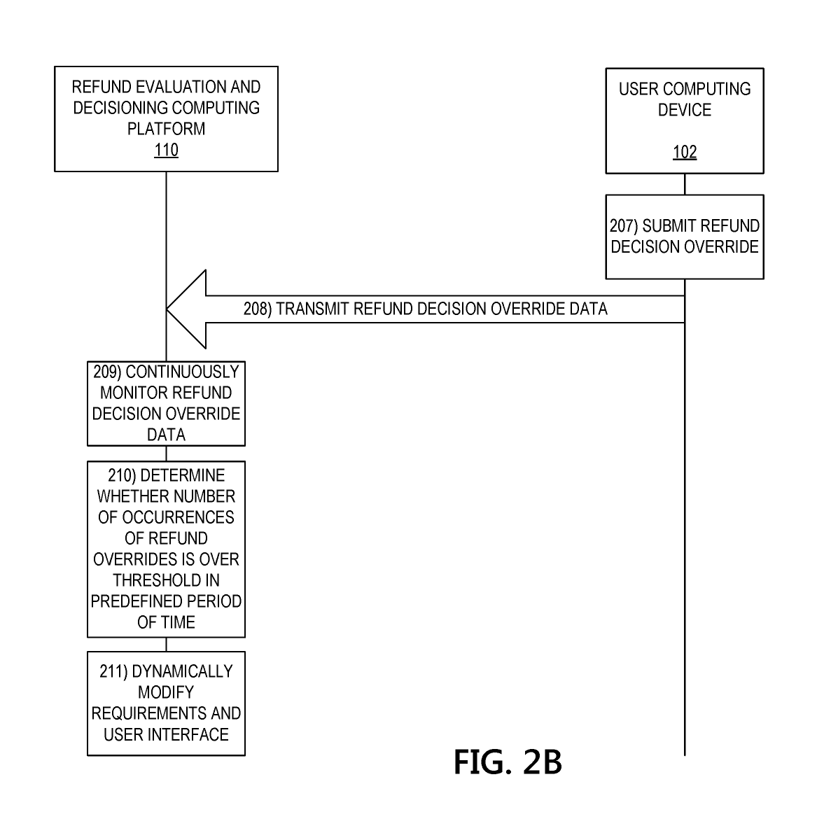

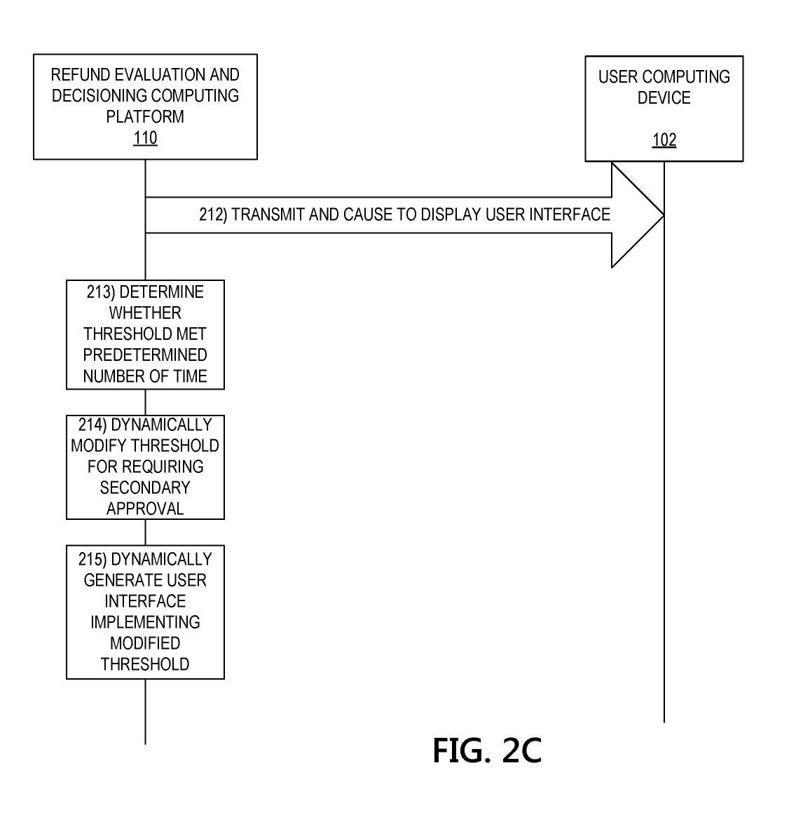

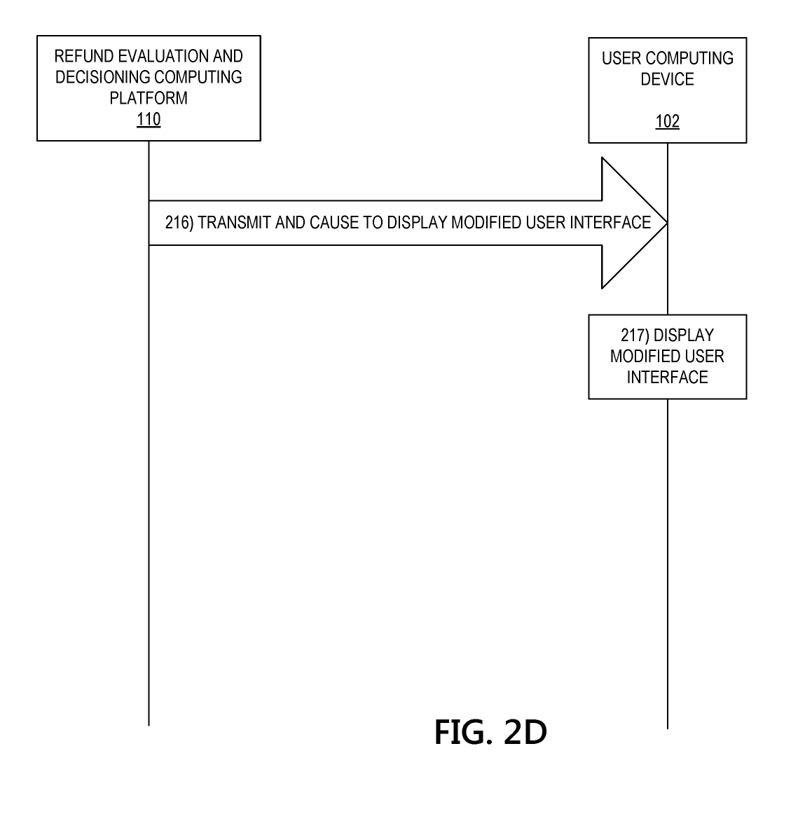

FIGS. 2A-2C illustrate one example event sequence for evaluating and decisioning refund requests in accordance with one or more aspects described herein. The sequence illustrated in FIGS. 2A-2C is merely one example sequence and various other events may be included, or events shown may be omitted, without departing from the invention.

With reference to FIG. 2A, in step 201, the computing platform 110 may determine or identify a plurality of users accessing the computing platform 110. For instance, the computing platform may identify a plurality of users that may be requesting refunds. In step 202, the computing platform may determine a threshold number of refund requests that may be made for a particular user, account, customer, or the like, before one or more parameters may be changed. For instance, the computing platform 110 may determine a prestored or predetermined threshold number of occurrences of a request for a refund that may be made by a particular user, customer or for a particular account, or the like, before, for instance, approval of a second user (e.g., supervisor, administrator, manager, or the like) is required.

In step 203, user input including one or more refund requests may be received from the plurality of identified users and via one or more computing devices 102. The refund requests may be received via a plurality of channels (e.g., in person, via an online application, via a call center, or the like). In step 204, the refund request data may be transmitted to the refund evaluation and decisioning computing platform 110 to determine a refund decision.

In step 205, the refund decision may be determined by, for instance, the refund decisioning module 118 in the refund evaluation and decisioning computing platform 110. As discussed herein, the refund decision may be based on various factors, data, and the like, including a type of account or produce, user requesting the refund, customer for whom the refund is requested, historical data, and the like. Further, data extracted from one or more sources for use in the decision may be controlled (e.g., source, type, amount, and the like) by the data control module 113. The computing platform 110 may automatically determine the refund decision, and, in step 206, the refund decision may be transmitted to one or more operations center computing devices 102.

With reference to FIG. 2B, in step 207, a user may submit an override of the refund decision (e.g., the refund decision denied the refund and the user override that decision and provide the refund). The refund decision override data may be transmitted from the operations center computing device 102 to the refund evaluation and decisioning computing platform 110 in step 207. If the user is authorized to override the refund (e.g., as determined by permissions module 114) the override may be completed. Alternatively, if a secondary authorization is required to perform the override, a request for that authorization may be transmitted to the operations center computing device 102.

In step 209, the refund evaluation and decisioning computing platform may continuously monitor (e.g., in real time) override data (e.g., requests to override, users associated with overrides, customers and/or accounts associated with overrides, and the like). In step 210, a determination may be made as to whether a number of occurrences of overrides is at or above a predetermined first threshold within a predefined period of time. If so, the computing platform 110 may dynamically modify one or more parameters and/or requirements of the system (e.g., a requirement for secondary authorization) and may dynamically modify one or more user interfaces used by one or more users to process events, request refunds, override refunds, or the like. The dynamically generated user interface may be transmitted to the computing device 102 in step 212 and the computing platform 110 may cause the dynamically modified user interface to be displayed on a display of the operations center computing device 102, as shown in FIG. 2C.

In step 213, upon determining that a first predefined threshold has been met, the computing platform 110 may analyze historical data to determine a number of times that the first predetermined threshold has been met for a particular user, a specific account or group of accounts, a particular customer or entity, or the like. If the number of times the first predefined threshold has been met meets or exceeds a second predetermined threshold, the system may dynamically modify the first predetermined threshold (e.g., threshold related to number of overrides) for modifying one or more parameters or requirements of the system. For instance, if the system determines that the number of times a first threshold has been met for a particular user meets or exceeds a second threshold, the system may dynamically modify the threshold number of request for requiring secondary approval for that particular user in step 214. In some examples, other users, accounts, customers, or the like, might not be subject to the modified threshold. Rather, the first threshold may be dynamically modified for only the user, customer, account, or the like, for which it is determined that the predetermined number of occurrences of the first threshold having been met meets or exceeds the second threshold.

In step 215, the computing platform 110 may dynamically modify and/or generate one or more user interfaces implementing the modified first threshold. For instance, a user interface being accessed by the user for whom the threshold was modified may view a different user interface than other users because the system may dynamically modify and/or generate a user interface particular to that user.

With reference to FIG. 2D, the dynamically modified and/or generated user interface may be transmitted to the operations center computing device 102 in step 216. The computing platform 110 may cause the dynamically modified and/or generated user interface to be displayed on a display of the operations center computing device 102, in step 217.

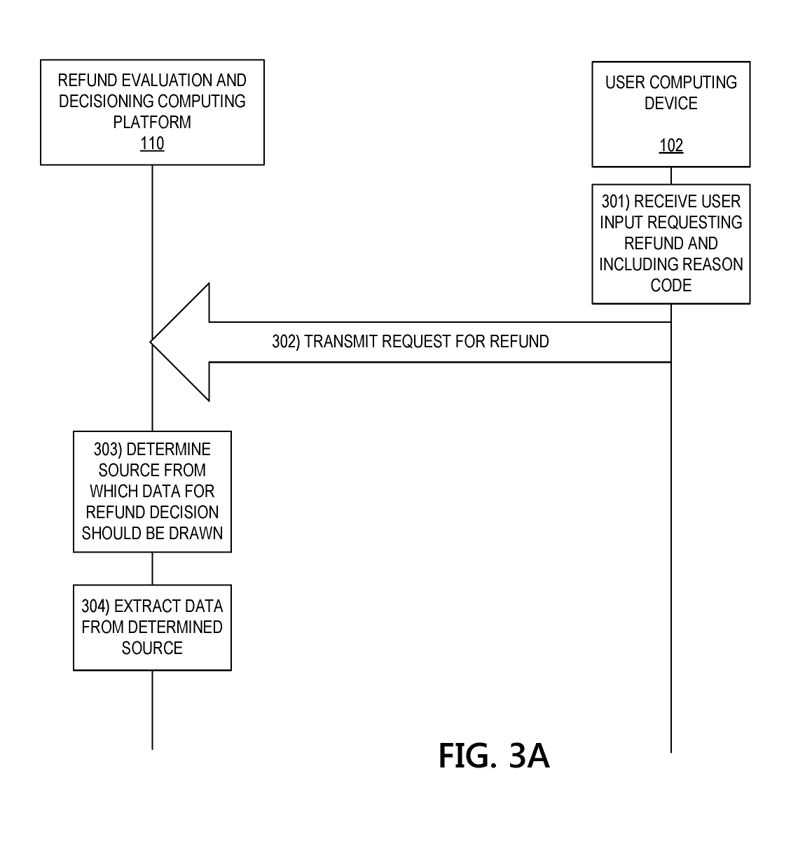

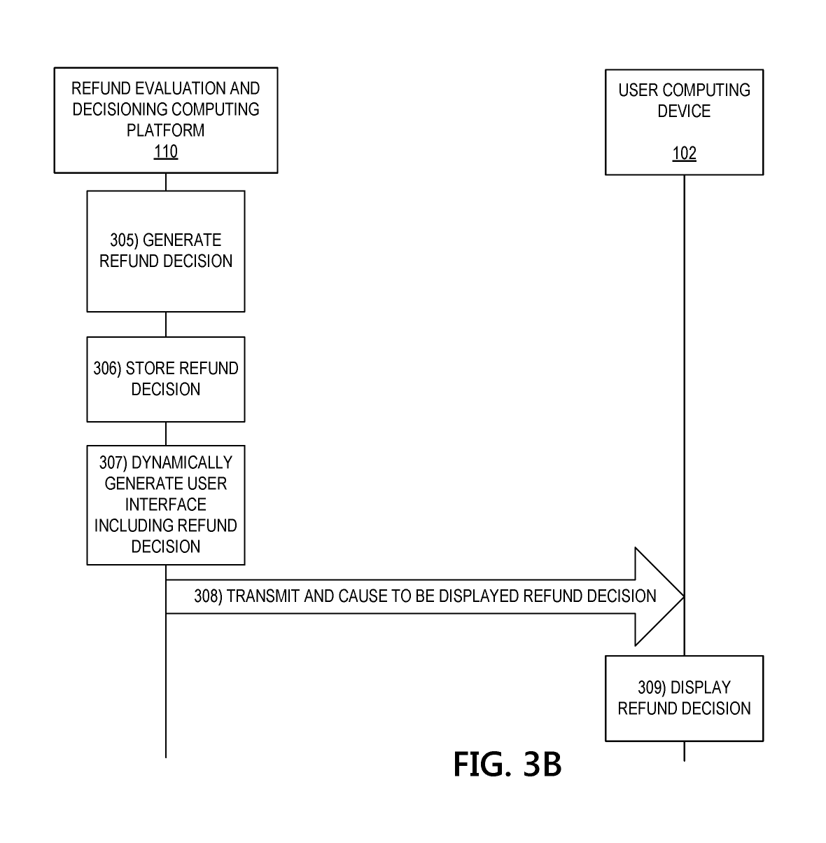

FIGS. 3A and 3B illustrate one example event sequence for controlling data provided for decisioning refund requests in accordance with one or more aspects described herein. The sequence illustrated in FIGS. 3A and 3B is merely one example sequence and various other events may be included, or events shown may be omitted, without departing from the invention.

With reference to FIG. 3A, in step 301, user input may be received requesting a refund and including additional data, such as a reason code. The user input may be received via operations center computing device 102 and the additional data may further include a customer associated with the requested refund, an account or product associated with the requested refund, and the like. The request for refund and additional data may be transmitted to the refund evaluation and decisioning computing platform 110 in step 302.

In step 303, one or more sources of data from which information to be used in the decisioning process may be identified. For instance, data control module 113 of refund evaluation and decisioning computing platform 110 may identify one or more sources of data based on the received refund request, refund code, and/or additional information. In some examples, the data control module 113 may apply one or more rules to the received information to identify one or more sources of data. Upon identifying the one or more sources of data, data may be extracted from the one or more identified sources in step 304. Extracting data from the one or more sources may include extracting data from only those sources and preventing data from one or more other sources from being used in the decisioning process. For instance, instructions and/or a query may be transmitted to one or more devices, databases, computing systems, or the like that have been identified as appropriate data sources requesting the desired information. In some examples, additionally, an instruction may be transmitted to one or more non-identified devices, databases, computing systems, or the like, instructing the device to not transmit information.

With reference to FIG. 3B, in step 305, a refund decision may be generated. For instance, the extracted information may be aggregated with other information provided in the refund request to decision the refund request. In some examples, historical data associated with previous refunds provided to the same customer, account, or the like, duration of a relationship between the customer and the entity, and the like, may be used in decisioning the refund.

In step 306, the refund decision may be stored, such as in database 119. The refund decision may be stored for use in future refund decisions. In some arrangements, the data type, source, amount, or the like, associated with making the decision may also be stored. In step 307, a user interface including the refund decision may be dynamically generated. For instance, a user interface may be generated indicating the refund decision and may also include information directed to the data sources from which data was extracted, one or more factors that impacted the decision, and the like.

In step 308, the refund evaluation and decisioning computing platform 110 may transmit the generated user interface to one or more computing devices 102 and may cause the user interface to be displayed on the one or more computing devices 102. In step 309, the decision and associated user interface may be displayed on the computing device 102.

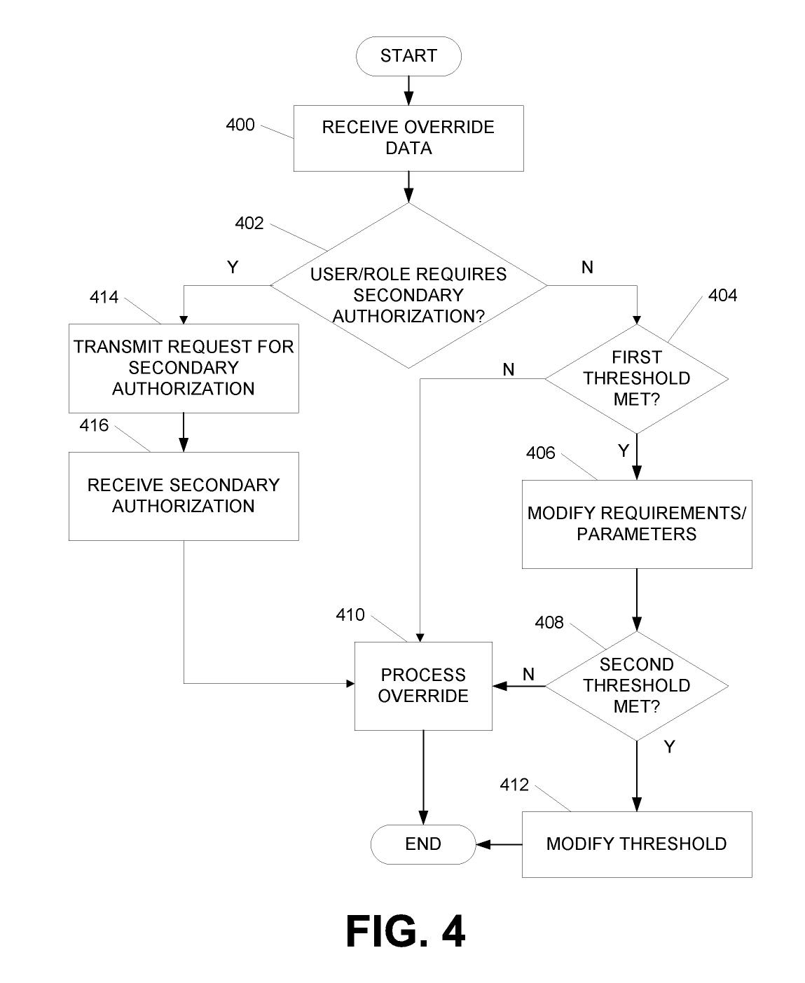

FIG. 4 illustrates one example method of determining whether an override threshold has been met, should be modified and/or whether one or more parameters or requirements should be modified according to one or more aspects described herein. In step 400, user override data may be received. The user override data may include data associated with overrides performed by one or more particular users (e.g., a banking associate, call center associate, or the like), associated with one or more particular accounts or group of accounts, one or more particular customers, or the like.

In step 402, a determination may be made as to whether the requested override requires secondary approval. For instance, in some arrangements, some users might not be authorized to override refund decisions without secondary approval. In some examples, the authorization to override a refund decision may be based on the user. In other examples, each user may have a role assigned to him or her and users in various roles may be eligible to override a refund decision while others might not.

If, in step 402, the requested override does not require secondary approval, a determination may be made in step 404 as to whether a first threshold has been met. For example, as discussed herein, the refund evaluation and decisioning computing platform 110 may continuously monitor refund data to determine whether a particular user, customer, account, or the like, has met or exceeded a predetermined first threshold number of overrides in a predefined time period. If not, the override may be processed in step 410.

If, in step 404, the first threshold has been met, one or more parameters or requirements may be modified in step 406. For instance, if the first threshold has been met, a user, customer, account, or the like, requesting an override or for which an override has been requested may now require secondary approval, whereas, prior to meeting the first threshold, the user, account, customer, or the like, might not have required secondary approval for the override.

In step 408, a determination may be made as to whether a second threshold has been met or exceeded. For instance, the refund evaluation and decisioning computing platform 110 may determine whether a particular user, account, customer, or the like, has met or exceeded the first predetermined threshold a second threshold number of times. If not, the override may be processed in step 410. If so, the first threshold may be dynamically modified (e.g., lowered such that parameters or requirements may be modified sooner or upon reaching a lower threshold, raised such that parameters or requirements may be modified later or upon reaching a higher threshold, or the like).

If, in step 402, the requested override does require secondary approval, the system or computing platform may transmit a request for secondary approval in step 414. The request may be transmitted to one or more computing devices 102. In step 416, second approval may be received and, in step 410, the override may be processed.

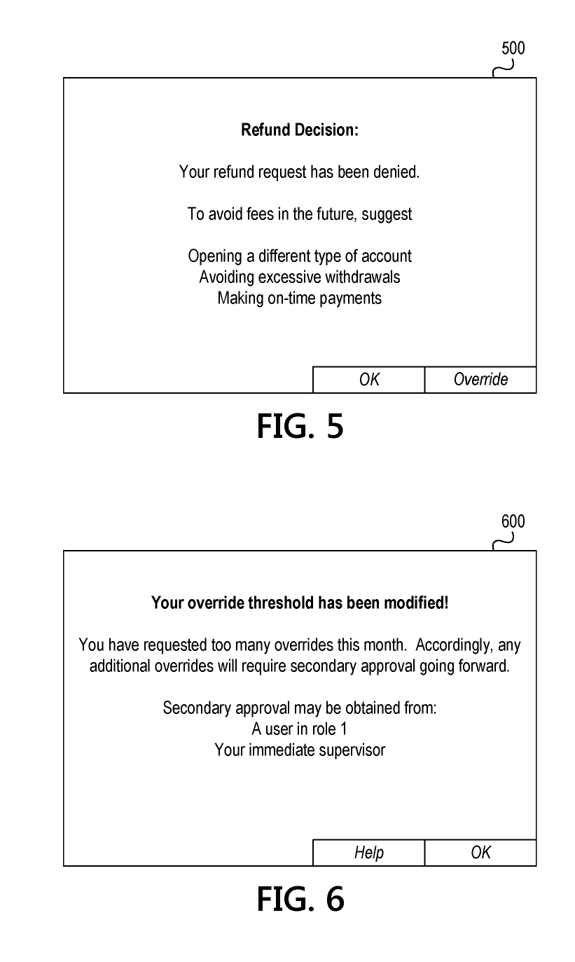

FIGS. 5 and 6 illustrate example user interfaces that may be dynamically generated according to one or more aspects described herein.

For instance, FIG. 5 includes a user interface 500 indicating a refund decision according to one or more aspects described herein. The user interface 500 may be dynamically generated, such as by dynamic user interface generation module 117 in response to a refund decision being determined. The interface includes the refund decision, as well as one or more suggestions that the user may provide to the customer to avoid fees in the future. The example suggestions shown in FIG. 5 are merely some examples. Various other suggestions may be provided without departing from the invention.

FIG. 6 illustrates one example user interface indicating that a refund override threshold has been modified according to one or more aspects described herein. The user interface 600 may be dynamically generated upon determining that a first threshold has been met or exceeded. The interface 600 may indicate that an override threshold has been reached and one or more parameters or requirements have been changed (e.g., secondary approval is now required). The interface 600 may further include information related to who may provide the secondary approval. In some examples, this information may be specific to the user, account, customer, or the like, for whom the user interface is being generated (e.g., the name of the user's immediate supervisor and/or contact information may be listed).

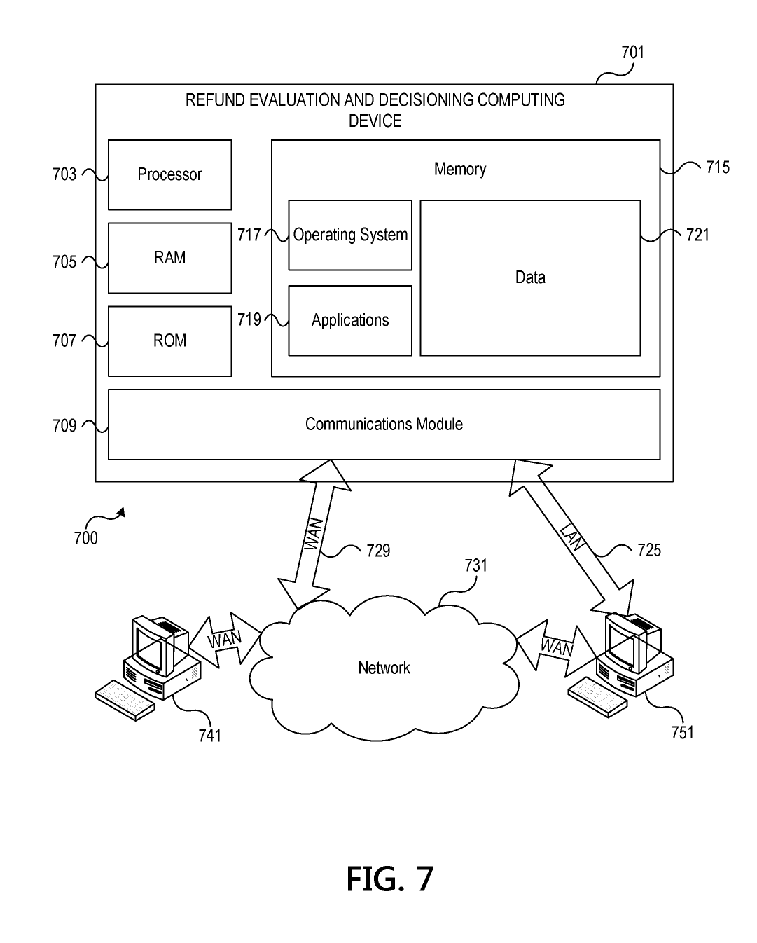

FIG. 7 depicts an illustrative operating environment in which various aspects of the present disclosure may be implemented in accordance with one or more example embodiments. Referring to FIG. 7, computing system environment 700 may be used according to one or more illustrative embodiments. Computing system environment 700 is only one example of a suitable computing environment and is not intended to suggest any limitation as to the scope of use or functionality contained in the disclosure. Computing system environment 700 should not be interpreted as having any dependency or requirement relating to any one or combination of components shown in illustrative computing system environment 700.

Computing system environment 700 may include refund evaluation and decisioning computing device 701 having processor 703 for controlling overall operation of refund evaluation and decisioning computing device 701 and its associated components, including random-access memory (RAM) 705, read-only memory (ROM) 707, communications module 709, and memory 715. Refund evaluation and decisioning computing device 701 may include a variety of computer readable media. Computer readable media may be any available media that may be accessed by refund evaluation and decisioning computing device 701, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 701.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on refund evaluation and decisioning computing device 701. Such a processor may execute computer-executable instructions stored on a computer-readable medium.

Software may be stored within memory 715 and/or storage to provide instructions to processor 703 for enabling refund evaluation and decisioning computing device 701 to perform various functions. For example, memory 715 may store software used by refund evaluation and decisioning computing device 701, such as operating system 717, application programs 719, and associated database 721. Also, some or all of the computer executable instructions for refund evaluation and decisioning computing device 701 may be embodied in hardware or firmware. Although not shown, RAM 705 may include one or more applications representing the application data stored in RAM 705 while refund evaluation and decisioning computing device 701 is on and corresponding software applications (e.g., software tasks) are running on refund evaluation and decisioning computing device 701.

Communications module 709 may include a microphone, keypad, touch screen, and/or stylus through which a user of refund evaluation and decisioning computing device 701 may provide input, and may also include one or more of a speaker for providing audio output and a video display device for providing textual, audiovisual and/or graphical output. Computing system environment 700 may also include optical scanners (not shown). Exemplary usages include scanning and converting paper documents, e.g., correspondence, receipts, and the like, to digital files.

Refund evaluation and decisioning computing device 701 may operate in a networked environment supporting connections to one or more remote computing devices, such as computing devices 741 and 751. Computing devices 741 and 751 may be personal computing devices or servers that include any or all of the elements described above relative to refund evaluation and decisioning computing device 701.

The network connections depicted in FIG. 7 may include local area network (LAN) 725 and wide area network (WAN) 729, as well as other networks. When used in a LAN networking environment, refund evaluation and decisioning computing device 701 may be connected to LAN 725 through a network interface or adapter in communications module 709. When used in a WAN networking environment, refund evaluation and decisioning computing device 701 may include a modem in communications module 709 or other means for establishing communications over WAN 729, such as network 731 (e.g., public network, private network, Internet, intranet, and the like). The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like and are configured to perform the functions described herein.

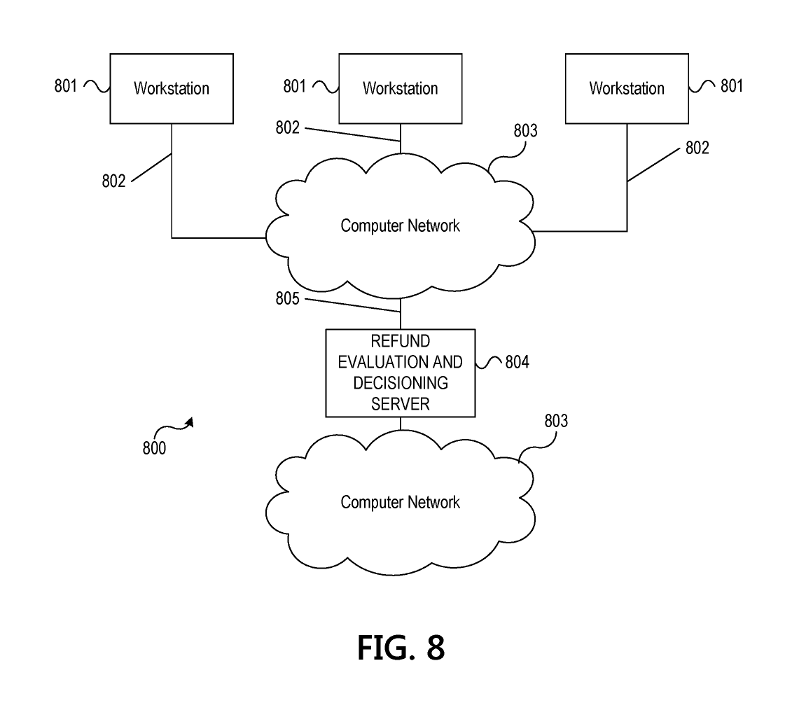

FIG. 8 depicts an illustrative block diagram of workstations and servers that may be used to implement the processes and functions of certain aspects of the present disclosure in accordance with one or more example embodiments. Referring to FIG. 8, illustrative system 800 may be used for implementing example embodiments according to the present disclosure. As illustrated, system 800 may include one or more workstation computers 801. Workstation 801 may be, for example, a desktop computer, a smartphone, a wireless device, a tablet computer, a laptop computer, and the like, configured to perform various processes described herein. Workstations 801 may be local or remote, and may be connected by one of communications links 802 to computer network 803 that is linked via communications link 805 to refund evaluation and decisioning server 804. In system 800, refund evaluation and decisioning server 804 may be any suitable server, processor, computer, or data processing device, or combination of the same, configured to perform the functions and/or processes described herein. Server 804 may be used to process the instructions received from one or more devices, process events, generate identifiers, and the like.

Computer network 803 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 802 and 805 may be any communications links suitable for communicating between workstations 801 and refund evaluation and decisioning server 804, such as network links, dial-up links, wireless links, hard-wired links, as well as network types developed in the future, and the like.

The systems and arrangements described herein generally include aspects directed to providing consistent objective decision for refund requests and monitoring of overrides of refund decisions. As discussed herein, the system provides an efficient, interactive way for users (such as banking associates, call center associates, and the like) to request a refund, provide reasons or additional information for requesting the refund (e.g., via one or more user interfaces including questions, responses, and the like) and/or request to override a refund decision.

In addition, the system may track user activity (including refund requests, overrides, reasoning for refund requests provided via the one or more user interfaces, and the like). As discussed herein, the system and arrangements may continuously monitor override requests for a user, customer, account, group of accounts, or the like, to determine whether a first threshold number of overrides within a predefined amount of time has been met. In some examples, the threshold may vary based on user, customer, length or duration of relationship between customer and entity, amount of refund being requested, role of the user, and the like. Accordingly, the thresholds may be customized to various situations and may be dynamically modifiable in order to effectively, efficiently and quickly change to accommodate different situations.

If the first threshold has been met, the system may quickly modify one or more parameters, such as requiring secondary authorization for an override, in order to ensure that not unauthorized activity is occurring. In addition, if the system determines that the first threshold has been met a second threshold number of times, the system may modify the first threshold and/or dynamically generate one or more user interfaces including and/or implementing the modified first threshold.

These and other aspects discussed herein provide for an efficient system for users to request and process refunds, while giving an entity control over refund decisioning, overrides, permissions to override a decision, and/or tracking of user activities with respect to refunds and overrides.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may comprise one or more non-transitory computer-readable media.

As described herein, the various methods and acts may be operative across one or more computing servers or platforms and one or more networks. The functionality may be distributed in any manner, or may be located in a single computing device (e.g., a server, a client computer, and the like), or across multiple computing devices. In such arrangements, any and/or all of the above-discussed communications between modules of the computing platform may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
a processor;
a communication interface communicatively coupled to the at least a first processor; and
a memory storing computer-readable instructions that, when executed by the at least one processor, cause the computing platform to:
identify a first threshold number of occurrences of an override request;
continuously monitor, in real-time, user input including override requests received from a plurality of users;
determine whether a number of occurrences of override requests from a first user of the plurality of users is above the first threshold in a first predetermined time period;
responsive to determining that the number of occurrences of override requests from the first user is above the first threshold in the first time period, dynamically modifying a parameter associated with override requests and dynamically generating a first user interface including the modified parameter;
cause to display the dynamically generated first user interface on a display of a computing device of the first user;
identify a second threshold number of occurrences of the first threshold having been met;
responsive to determining that number of occurrences of override requests from the first user is above the first threshold in the first time period, determine whether a number of occurrences of the first threshold being met is above the second threshold;
responsive to determining that the number of occurrences of the first threshold being met is above the second threshold, dynamically modifying the first threshold and dynamically generating a second user interface including the dynamically modified first threshold; and
cause to display the second dynamically generated user interface on the display of the computing device of the first user.

2. The computing platform of claim 1, wherein the parameter associated with override requests includes a requirement to obtain secondary authorization from a second user different from the first user.

3. The computing platform of claim 1, wherein dynamically generating the first and second user interfaces includes dynamically generating a first and second user interface particular to the first user.

4. The computing platform of claim 3, wherein dynamically generating the first and second user interfaces particular to the first user includes generating information directed to reasons for modifying the parameter and modifying the first threshold.

5. The computing platform of claim 1, further including instructions that, when executed, cause the computing platform to:
identify a third threshold number of override requests;
continuously monitor, in real-time, user input including override requests received for a particular customer;
determine whether a number of occurrences of override requests for the particular customer is above the third threshold in a second predetermined time period;
responsive to determining that the number of occurrences of override requests for the particular customer is above the third threshold in the second time period, dynamically modifying the parameter associated with override requests and dynamically generating a third user interface including the modified parameter;
cause to display the dynamically generated third user interface on a display of a computing device of the first user;
identify a fourth threshold number of occurrences of the third threshold having been met;
responsive to determining that number of occurrences of override requests for the particular customer is above the third threshold in the second time period, determine whether a number of occurrences of the third threshold being met is above the fourth threshold;
responsive to determining that the number of occurrences of the third threshold being met is above the fourth threshold, dynamically modifying the third threshold and dynamically generating a fourth user interface including the dynamically modified third threshold; and
cause to display the fourth dynamically generated user interface on the display of the computing device of the first user.

6. The computing platform of claim 1, further including instructions that, when executed, cause the computing platform to:
identify a third threshold number of override requests;
continuously monitor, in real-time, user input including override requests received for one of: an account and a group of accounts;
determine whether a number of occurrences of override requests for the at least one of the account and the group of accounts is above the third threshold in a second predetermined time period;
responsive to determining that the number of occurrences of override requests for the at least one of the account and the group of accounts is above the third threshold in the second time period, dynamically modifying the parameter associated with override requests and dynamically generating a third user interface including the modified parameter;
cause to display the dynamically generated third user interface on a display of a computing device of the first user;
identify a fourth threshold number of occurrences of the third threshold having been met;
responsive to determining that number of occurrences of override requests for the at least one of the account and the group of accounts is above the third threshold in the second time period, determine whether a number of occurrences of the third threshold being met is above the fourth threshold;
responsive to determining that the number of occurrences of the third threshold being met is above the fourth threshold, dynamically modifying the third threshold and dynamically generating a fourth user interface including the dynamically modified third threshold; and
cause to display the fourth dynamically generated user interface on the display of the computing device of the first user.

7. The computing platform of claim 1, further including instructions that, when executed, cause the computing platform to:
receive user input requesting a refund, the user input including a reason code and additional information;
determine one or more sources of data for use in determining a refund decision in response to the request for a refund;
extract, from the determined one or more sources of data, information to generate the refund decision, extracting the data including controlling at least one of: a type of data and an amount of data; and
determining the refund decision based on the extracted data.

8. A method, comprising:
identifying, by a refund evaluation and decisioning server, a first threshold number of occurrences of an override request;
continuously monitoring, by the refund evaluation and decisioning server and in real-time, user input including override requests received from a plurality of users;
determining, by the refund evaluation and decisioning server, whether a number of occurrences of override requests from a first user of the plurality of users is above the first threshold in a first predetermined time period;
responsive to determining that the number of occurrences of override requests from the first user is above the first threshold in the first time period, dynamically modifying, by the refund evaluation and decisioning server, a parameter associated with override requests and dynamically generating a first user interface including the modified parameter;
causing to display, by the refund evaluation and decisioning server, the dynamically generated first user interface on a display of a computing device of the first user;
identifying, by the refund evaluation and decisioning server, a second threshold number of occurrences of the first threshold having been met;
responsive to determining that number of occurrences of override requests from the first user is above the first threshold in the first time period, determining, by the refund evaluation and decisioning server, whether a number of occurrences of the first threshold being met is above the second threshold;
responsive to determining that the number of occurrences of the first threshold being met is above the second threshold, dynamically modifying, by the refund evaluation and decisioning server, the first threshold and dynamically generating a second user interface including the dynamically modified first threshold; and
causing to display, by the refund evaluation and decisioning server, the second dynamically generated user interface on the display of the computing device of the first user.

9. The method of claim 8, wherein the parameter associated with override requests includes a requirement to obtain secondary authorization from a second user different from the first user.

10. The method of claim 8, wherein dynamically generating the first and second user interfaces includes dynamically generating a first and second user interface particular to the first user.

11. The method of claim 10, wherein dynamically generating the first and second user interfaces particular to the first user includes generating information directed to reasons for modifying the parameter and modifying the first threshold.

12. The method of claim 8, further including:
identifying, by the refund evaluation and decisioning server, a third threshold number of override requests;
continuously monitoring, by the refund evaluation and decisioning server and in real-time, user input including override requests received for a particular customer;
determining, by the refund evaluation and decisioning server, whether a number of occurrences of override requests for the particular customer is above the third threshold in a second predetermined time period;
responsive to determining that the number of occurrences of override requests for the particular customer is above the third threshold in the second time period, dynamically modifying, by the refund evaluation and decisioning server, the parameter associated with override requests and dynamically generating a third user interface including the modified parameter;
causing to display, by the refund evaluation and decisioning server, the dynamically generated third user interface on a display of a computing device of the first user;
identifying, by the refund evaluation and decisioning server, a fourth threshold number of occurrences of the third threshold having been met;
responsive to determining that number of occurrences of override requests for the particular customer is above the third threshold in the second time period, determining, by the refund evaluation and decisioning server, whether a number of occurrences of the third threshold being met is above the fourth threshold;
responsive to determining that the number of occurrences of the third threshold being met is above the fourth threshold, dynamically modifying, by the refund evaluation and decisioning server, the third threshold and dynamically generating a fourth user interface including the dynamically modified third threshold; and
causing to display, by the refund evaluation and decisioning server, the fourth dynamically generated user interface on the display of the computing device of the first user.

13. The method of claim 8, further including:
identifying, by the refund evaluation and decisioning server, a third threshold number of override requests;
continuously monitoring, by the refund evaluation and decisioning server and in real-time, user input including override requests received for one of: an account and a group of accounts;
determining, by the refund evaluation and decisioning server, whether a number of occurrences of override requests for the at least one of the account and the group of accounts is above the third threshold in a second predetermined time period;
responsive to determining that the number of occurrences of override requests for the at least one of the account and the group of accounts is above the third threshold in the second time period, dynamically modifying, by the refund evaluation and decisioning server, the parameter associated with override requests and dynamically generating a third user interface including the modified parameter;
causing to display, by the refund evaluation and decisioning server, the dynamically generated third user interface on a display of a computing device of the first user;
identifying, by the refund evaluation and decisioning server, a fourth threshold number of occurrences of the third threshold having been met;
responsive to determining that number of occurrences of override requests for the at least one of the account and the group of accounts is above the third threshold in the second time period, determining, by the refund evaluation and decisioning server, whether a number of occurrences of the third threshold being met is above the fourth threshold;
responsive to determining that the number of occurrences of the third threshold being met is above the fourth threshold, dynamically modifying, by the refund evaluation and decisioning server, the third threshold and dynamically generating a fourth user interface including the dynamically modified third threshold; and
causing to display, by the refund evaluation and decisioning server, the fourth dynamically generated user interface on the display of the computing device of the first user.

14. The method of claim 8, further including:
receiving, by the refund evaluation and decisioning server, user input requesting a refund, the user input including a reason code and additional information;
determining, by the refund evaluation and decisioning server, one or more sources of data for use in determining a refund decision in response to the request for a refund;
extracting, by the refund evaluation and decisioning server and from the determined one or more sources of data, information to generate the refund decision, extracting the data including controlling at least one of: a type of data and an amount of data; and
determining, by the refund evaluation and decisioning server, the refund decision based on the extracted data.

15. One or more non-transitory computer-readable media storing instructions that, when executed by a computer system comprising at least one processor, memory, and a communication interface, cause the computer system to:
identify a first threshold number of occurrences of an override request;
continuously monitor, in real-time, user input including override requests received from a plurality of users;
determine whether a number of occurrences of override requests from a first user of the plurality of users is above the first threshold in a first predetermined time period;
responsive to determining that the number of occurrences of override requests from the first user is above the first threshold in the first time period, dynamically modifying a parameter associated with override requests and dynamically generating a first user interface including the modified parameter;
cause to display the dynamically generated first user interface on a display of a computing device of the first user;
identify a second threshold number of occurrences of the first threshold having been met;
responsive to determining that number of occurrences of override requests from the first user is above the first threshold in the first time period, determine whether a number of occurrences of the first threshold being met is above the second threshold;
responsive to determining that the number of occurrences of the first threshold being met is above the second threshold, dynamically modifying the first threshold and dynamically generating a second user interface including the dynamically modified first threshold; and
cause to display the second dynamically generated user interface on the display of the computing device of the first user.

16. The one or more non-transitory computer-readable media of claim 15, wherein the parameter associated with override requests includes a requirement to obtain secondary authorization from a second user different from the first user.

17. The one or more non-transitory computer-readable media of claim 15, wherein dynamically generating the first and second user interfaces includes dynamically generating a first and second user interface particular to the first user.

18. The one or more non-transitory computer-readable media of claim 17, wherein dynamically generating the first and second user interfaces particular to the first user includes generating information directed to reasons for modifying the parameter and modifying the first threshold.

19. The one or more non-transitory computer-readable media of claim 15, further including instructions that, when executed, cause the computing platform to:
identify a third threshold number of override requests;
continuously monitor, in real-time, user input including override requests received for a particular customer;
determine whether a number of occurrences of override requests for the particular customer is above the third threshold in a second predetermined time period;
responsive to determining that the number of occurrences of override requests for the particular customer is above the third threshold in the second time period, dynamically modifying the parameter associated with override requests and dynamically generating a third user interface including the modified parameter;
cause to display the dynamically generated third user interface on a display of a computing device of the first user;
identify a fourth threshold number of occurrences of the third threshold having been met;
responsive to determining that number of occurrences of override requests for the particular customer is above the third threshold in the second time period, determine whether a number of occurrences of the third threshold being met is above the fourth threshold;
responsive to determining that the number of occurrences of the third threshold being met is above the fourth threshold, dynamically modifying the third threshold and dynamically generating a fourth user interface including the dynamically modified third threshold; and
cause to display the fourth dynamically generated user interface on the display of the computing device of the first user.

20. The one or more non-transitory computer-readable media of claim 15, further including instructions that, when executed, cause the computing platform to:
identify a third threshold number of override requests;
continuously monitor, in real-time, user input including override requests received for one of: an account and a group of accounts;
determine whether a number of occurrences of override requests for the at least one of the account and the group of accounts is above the third threshold in a second predetermined time period;
responsive to determining that the number of occurrences of override requests for the at least one of the account and the group of accounts is above the third threshold in the second time period, dynamically modifying the parameter associated with override requests and dynamically generating a third user interface including the modified parameter;
cause to display the dynamically generated third user interface on a display of a computing device of the first user;
identify a fourth threshold number of occurrences of the third threshold having been met;
responsive to determining that number of occurrences of override requests for the at least one of the account and the group of accounts is above the third threshold in the second time period, determine whether a number of occurrences of the third threshold being met is above the fourth threshold;
responsive to determining that the number of occurrences of the third threshold being met is above the fourth threshold, dynamically modifying the third threshold and dynamically generating a fourth user interface including the dynamically modified third threshold; and
cause to display the fourth dynamically generated user interface on the display of the computing device of the first user.

21. The one or more non-transitory computer-readable media of claim 15, further including instructions that, when executed, cause the computing platform to:
receive user input requesting a refund, the user input including a reason code and additional information;
determine one or more sources of data for use in determining a refund decision in response to the request for a refund;
extract, from the determined one or more sources of data, information to generate the refund decision, extracting the data including controlling at least one of: a type of data and an amount of data; and
determining the refund decision based on the extracted data.
